(19) United States
(12) Patent Application Publication
(10) Pub. No.: US 2010/0236415 A1
(43) Pub. Date: Sep. 23, 2010

(54) APPARATUS AND METHOD FOR PRESERVING WINE

(76) Inventor: Martin Edward Rimmer, Surrey (GB)

Correspondence Address: BURNS & LEVINSON, LLP, 125 SUMMER STREET, BOSTON, MA, 02110, US

(21) Appl. No.: 12/680,950

(22) PCT Filed: Oct. 2, 2008
(86) PCT No.: PCT/GB2008/003326

§ 371 Date: May 11, 2010

(30) Foreign Application Priority Data
Oct. 2, 2007 (GB) 0719325.3

(51) Int. Cl. C12H 1/22

(52) U.S. Cl. 99/277.1

(57) ABSTRACT

The present invention relates to a kit to seal and preserve a partly drunk bottle of wine by injecting and leaving an unpressurised blanket of inert gas into the bottle through a self-sealing stopper (20). The device (10) contains a replaceable canister of compressed gas and is designed so that the whole injecting of gas process is carried out with a simple push down of the device onto the bottle. At the end of the process the wine will be kept in perfect condition for many months by leaving the stopper (20) in the bottle.

The present invention relates a method for preserving wine after opening of a bottle so that the wine does not oxidise or otherwise deteriorate. A device and kit for this purpose are also provided.

There have been many suggestions previously made to prevent wine deteriorating after the bottle has been opened. The simplest is to replace the cork after opening or screw cap. However, this leaves air above the wine which allows the wine to oxidise thus impairing the flavour of the remaining wine. It has therefore been suggested to use a device to remove the air from the bottle after re-sealing so that a vacuum is created over the liquid. Although this is successful in preventing oxidation, the wine still deteriorates because gas, typically carbon dioxide, dissolved in the wine is removed by the vacuum leaving the wine lifeless.

It has been suggested to replace the air in the bottle with another gas which does not oxidise the wine, for example in US-A-2006/0260324, WO-A-2004/066749 and U.S. Pat. No. 5,566,730. Although these devices should, in principle, be effective, the devices are complex to use and in many cases manufacture.

The present invention seeks to provide a method and device which prevents deterioration of wine in a bottle after initial opening yet is simple to use.

According to a first aspect of the present invention there is provided a device for preserving wine in a bottle, comprising a housing having a movable wall movable between a wall first position and a wall second position and having an injector aperture therethrough, the housing containing an elongate injector extending from a gas supply to a distal end, wherein the distal end of the injector extends through the injector aperture by less than a preset amount in the wall first position and by more than the preset amount in the wall second position. As explained in more detail hereinafter this simple device is easy to use. The housing is preferably sized for one-handed operation, so that the user can hold the device in one hand and steady the wine bottle with the other hand.

Preferably, the movable wall is biased into the first wall position as this prevents damage to the injector and injury caused thereby. The movable wall is normally provided as slidably movable within a cylindrical sidewall of the housing as this is simple to construct and prevents access to the workings of the device thus again preventing damage or injury. The cylindrical sidewall will normally have a non-circular cross-section, e.g. D-shaped that will be large enough so that it can comfortably fit over the neck of an average wine bottle whilst not being too large.

The gas supply will normally be a pressurised gas cylinder filled with a non-oxygenating gas such as argon, carbon dioxide, helium, nitrogen or mixtures thereof. The gas cylinder will be wholly contained within the housing.

In a preferred embodiment of the invention, the injector is fluidly connected to the gas supply via a valve which allows fluid connection between the gas supply to the injector in the wall second position and prevents said fluid connection gas from the gas supply in the wall first position. The valve can thus be automatically controlled, e.g. by a link coupled to the movable wall. Advantageously, the valve switches between allowing fluid flow and preventing fluid flow when the movable wall is in an intermediate position between the first and second position. It is best if the gas within the bottle is under atmospheric pressure and so this intermediate position allows gas supply to be stopped whilst still allowing excess gas to be released from the bottle.

The device will preferably have an elongate exhaust pipe extending from the housing interior to a distal end so that the release of gas pressure from the bottle can also be controlled in a simple manner. The exhaust pipe is normally provided so as to be generally parallel with the injector. It may even for a tube about the injector. In any case the gas flow through the exhaust may be controlled so that flow is allowed when the movable wall is in the intermediate position so that pressure can be released.

Advantageously, the exhaust pipe distal end extends through the movable wall in the wall second position less than the injector distal end so that the non-oxygenating gas under pressure is introduced through the injector and the gas above the injector, namely the unwanted air, is removed through the exhaust. Normally, the housing includes a port for preventing gas pressure to become elevated therein.

It is preferred for the housing to have a removable end cap for access to the gas supply as this allows simple changing of the gas supply by the user in a home environment.

According to a second aspect of the invention there is provided a kit comprising the device according to the first aspect and a stopper comprising a generally gas impervious body extending from a top face to a bottom face. Often the kit will include several stoppers so that the invention can prevent deterioration of several bottle of wine at the same time.

The top face of the stopper will normally include an injector opening for the injector. The injector will then penetrate through the stopper in to the wine bottle a predetermined amount when the movable wall is moved to its second position. In similar fashion, the top face of the stopper may include an opening for the exhaust pipe. Neither the injector nor exhaust pipe have to extend all the way through the stopper, as the stopper could be provided with internal pipes which depend into the wine bottle themselves.

The stopper includes one or more fluid channels between the top face and bottom face which allow fluid connection therebetween only when the movable wall of the device is in the wall second position. Thus the fluid channels may either have valves, or the stopper can be made from a self-sealing material.

Preferably, the stopper has a non-circular cross-section, for example D-shaped. This will be matched with the shape of the sidewall of the device to allow sidewall to slide over the exterior edge of the stopper. The non-circular cross-section allow the two to fit together in only one orientation thus ensuring that the injector can accurately penetrate the desired part of the stopper.

According to a third aspect of the present invention, there is provided a method of re-corking a wine bottle having liquid up to a level therein using the kit according to the second aspect of the invention, the method comprising the steps of:
a) introducing the stopper into an open wine bottle;
b) aligning the injector aperture with the injector opening;
c) bringing the movable wall in the wall first position against the top face of the stopper;
d) moving the movable wall to the wall second position by pushing the device against the top face of the stopper;
e) keeping the device with the movable wall in the wall second position for a period sufficient to substantially displace the air above the liquid level with the gas from the gas supply; and
f) separating the device from the stopper with the stopper remaining in the wine bottle.

The invention will now be described with reference to the accompanying drawings which show:

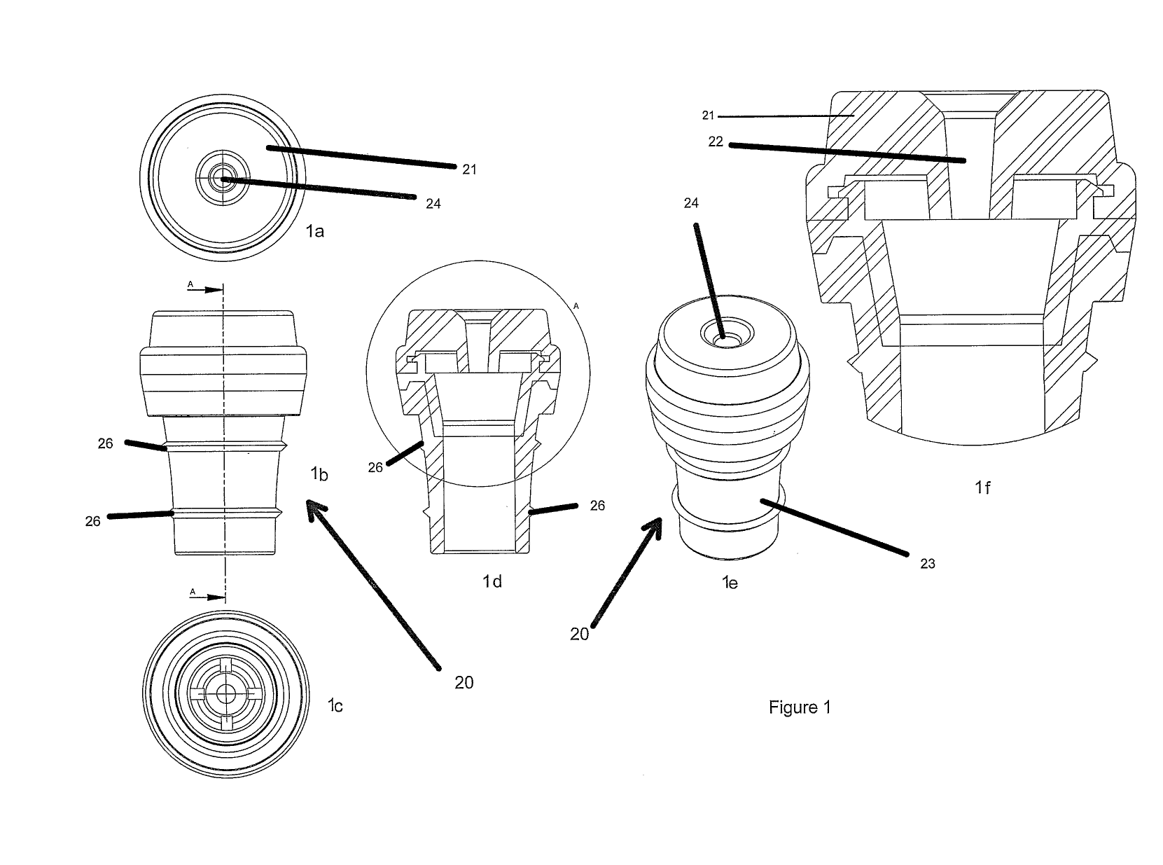

FIG. 1 shows views of a stopper for use in a preferred embodiment of the invention;

FIG. 1a is a top plan view;

FIG. 1b is a side view;

FIG. 1c is a bottom plan view;

FIG. 1d shows a cross-section through the middle of the stopper along the line A-A;

FIG. 1e is a perspective view of the stopper; and shows a detailed view of area A of FIG. 1e;

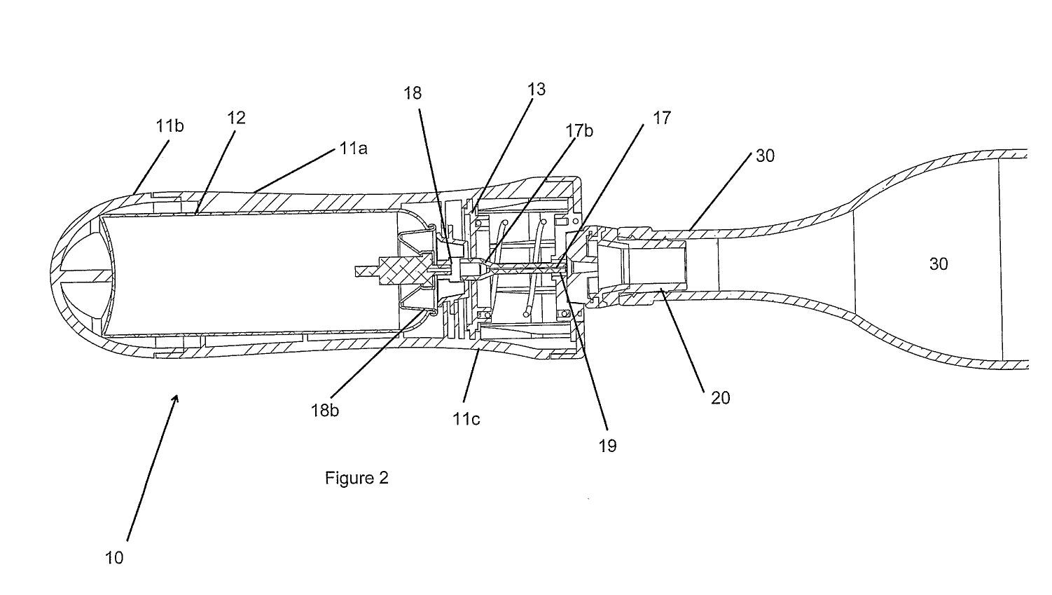

FIG. 2 is a cross-sectional side view through the kit according to a preferred embodiment of the present invention in a first position;

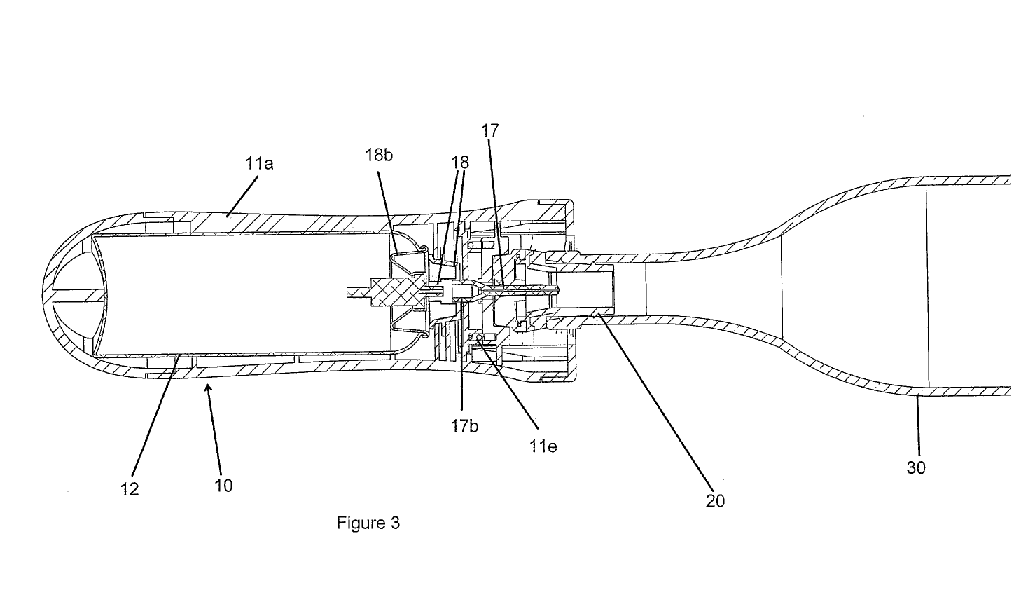

FIG. 3 shows the kit of FIG. 2 moved to a second position;

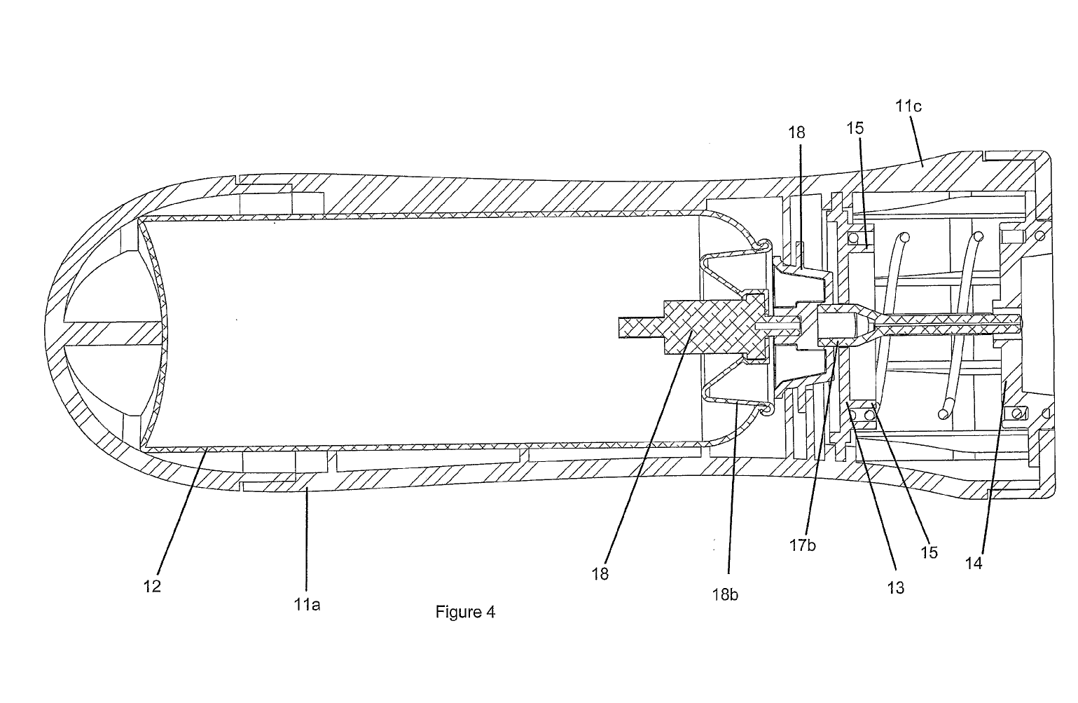

FIG. 4 is a cross-sectional side view through a device according to a preferred embodiment of the present invention in a first position;

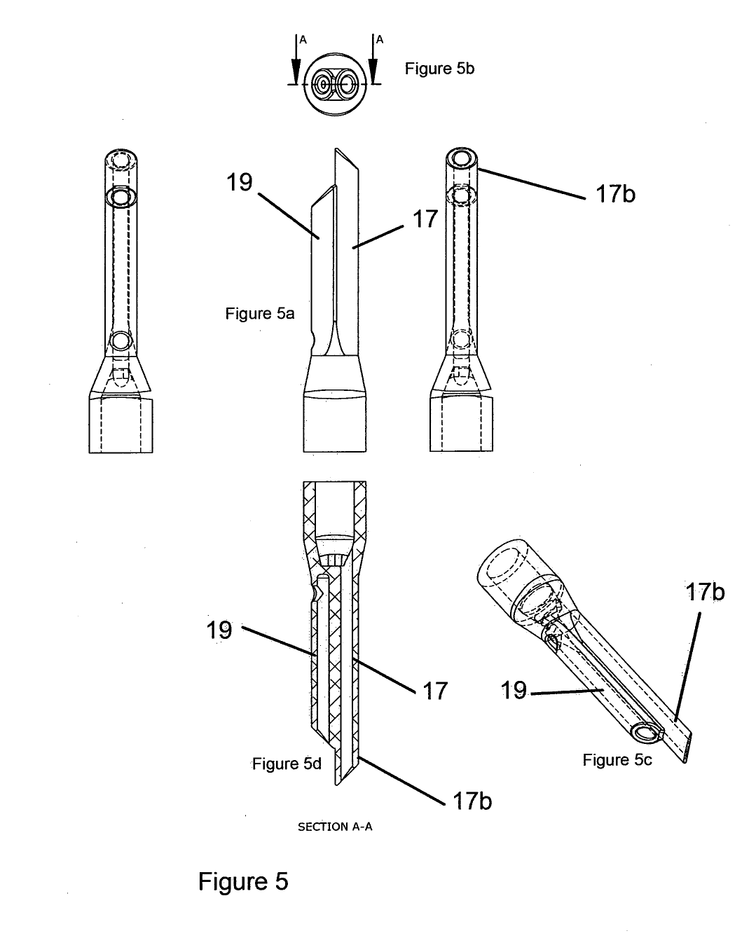

FIG. 5 are views of the injector and exhaust of a preferred embodiment of the present invention;

FIG. 5a is a side plan view;

FIG. 5b is a top plan view;

FIG. 5c is a detailed perspective view;

FIG. 5d a section view along the line A-A of FIG. 5b;

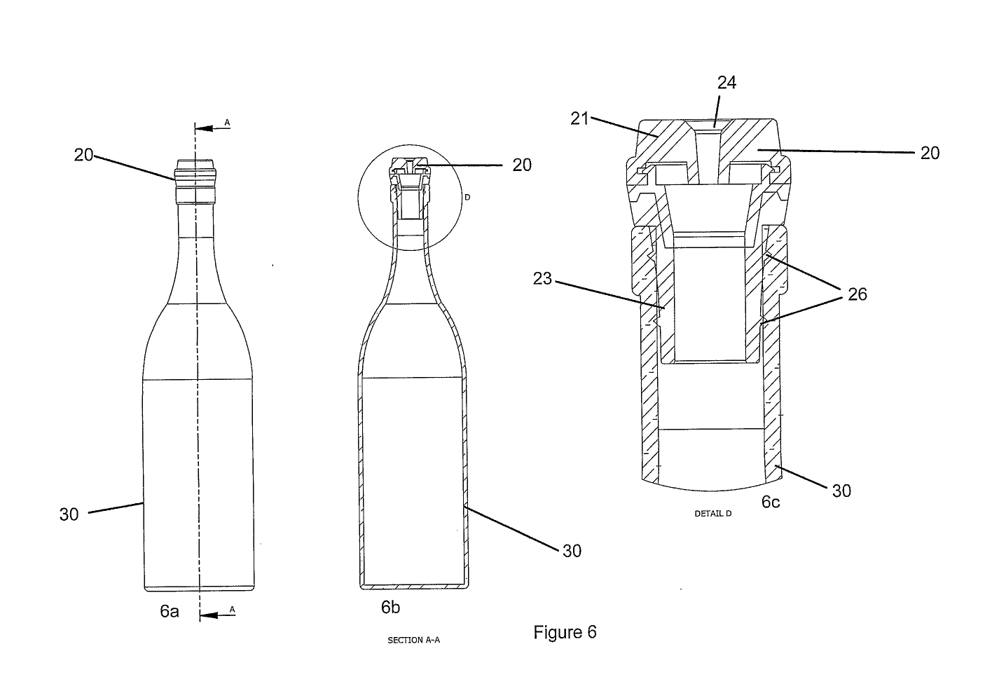

FIG. 6 are views of the stopper of a preferred embodiment of the present invention;

FIG. 6a is a side plan view;

FIG. 6b is a section view along the line A-A of FIG. 6a

FIG. 6c is a detailed of area d of FIG. 6b; and

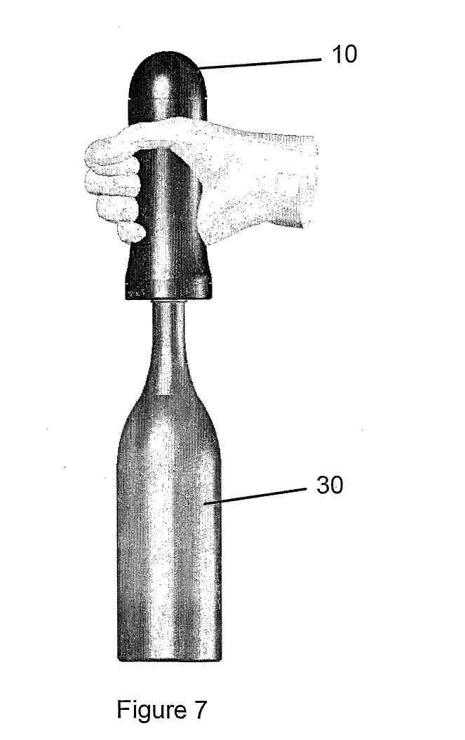

FIG. 7 is a perspective view of a preferred embodiment of the invention in use.

FIG. 1 show a stopper 20 with a top part 21 and a bottom part 23. The stopper 20 will normally be made from natural rubber, neoprene or combinations thereof, or other materials as well known in the art. The stopper 20 has a single channel 22 extending therethrough the top part 21 from openings 24. The channels include self-sealing valves. The bottom part 23 is in the form of a cylinder with circular cross-section with two ribs 26 extending around the cylinder to hold the stopper 20 in place in the neck of a bottle 30 as shown in FIG. 6.

FIGS. 2 and 3 show a kit according to the invention in two positions comprising the stopper 20 and device 10. FIG. 2 shows a first position with the device 10 resting on the stopper 20 in the neck of bottle 30. FIG. 3 shows a second position which is explained in more detail below.

The device 10 shown comprises a housing 11 which has three sections. The main section 11a is shaped to be gripped by a users hand as shown in FIG. 7. The housing 11 has an aperture which acts as a vent. The cap 11b removably engages the main section 11a and provides access to the gas canister 12. Sidewall section 11c is generally cylindrical and depends from the main section 11a and is integral therewith. The sidewall section 11c, as best seen in FIG. 6c, has a circular cross-section which must match the cross-section of the stopper top part 21 so that the sidewall 11c can slide over the top part 21.

As best seen in FIGS. 2 to 4 the housing 11 has a movable wall 14. A helical spring 16 which acts between the movable wall 14 and the internal wall 13 to bias the movable wall 14 into the first position shown in FIG. 2. The movable wall 14 is movable through a force acting to compress spring 16 to a second position close to the internal wall 13 as shown in FIG. 3.

The device 10 includes an injector 17 which extends from the gas canister 12 through the internal wall 13 to a distal end 17a within sidewall 11c. The injector 17 is positioned so that the injector 17 extends through an injector hole in the movable wall 14 when the movable wall is in the second position shown in FIG. 3. The injector 17 is fluidly connectable to a valve 18 which controls the flow of gas through the injector 17. The gas canister 12 contains a non-oxygenating gas such as nitrogen, carbon dioxide, argon, helium or mixtures thereof under pressure. The valve 18 is coupled to collar 17b of the injector 17. As the movable wall 14 moves between the first position and second position, the valve 18 moves between a closed position where no gas flows through the injector and an open position where gas flows through the valve 18 and the injector 17. The valve 18 is in the closed position when the movable wall 14 is in the first position shown in FIG. 2 and in the open position when the movable wall 14 is in the second position shown in FIG. 3. The movable wall 14 abuts stops 11e in the second position which stop 11e prevents further movement towards the interior of the housing 11 by the movable wall 14. The valve 18 switches between the closed position and the open position when the movable wall presses on to the collar 17b of the injector 17. The valve 18 is biased closed by spring 18b.

The device 10 also has an exhaust pipe 19 which extends from adjacent the wall 13 through the movable wall 14 to a distal end 19a. The exhaust pipe 19 extends generally parallel to the injector 17 but the distal end 17a thereof is spaced further from the movable wall 14 when the movable wall 14 is in the first position. This is to prevent gas injector immediately being exhausted.

As shown in FIG. 2, the movable wall 14 in the first position rests on the stopper 20 top surface with the stopper he neck of the bottle 30. The channel 22 is closed to prevent gas passing through the channels 22.

The position shown in FIG. 3 shows the device 20 with the movable wall in the second position. The movable wall 14 is pressed down against the spring 16 onto the stopper 20 so that the injector 17 and the exhaust pipe 19 pass through the hole in to the channel 22, opening up the seals in channel 22 so that gas can flow through the injector 17 and the exhaust 19. In this second position the distal end 17a of the injector 17 and the distal end 19a of the exhaust pipe 19 pass into the bottle 30 within the wall of the bottom part 23 of the stopper 20.

The position shown in FIG. 3 shows the device 20 with the movable wall in the second position. The valve 18 moves to the open position and releases gas under pressure from the gas canister 12 into the bottle 30 the through the injector 17 when the movable wall 14 presses on collar 17b of the injector as the collar is coupled to the valve 18. The valve 18 is biased back to a closed position by spring 18b. The effect of this is to inject inert gas through the injector 17 into the bottle 30 and blow the air out of the bottle 30 through the exhaust pipe 19 and out into the atmosphere through the vent.

When sufficient gas has been injected into the bottle 30, less downward hand pressure is used and the device moved back to the first position of the movable wall shown in FIGS. 2 and 4 so that gas is no longer released as the valve 18 is moved back to the off position. Any excess pressure of gas in the bottle will continue to be released back to the atmosphere via exhaust pipe 19 through the vent, until the device is moved back to the position injector 17 and the exhaust pipe 19 fully retracted back inside the sidewall 11c, in which position the channel 22 is closed, sealing in the inert gas and preserving the wine in the bottle 30.

In an alternative embodiment, not shown, the cross-section of sidewall 11c and stopper top part 21 can be D-shaped, or other shape if it is desired to only fit in a particular orientation. Thus, when in use, the device 10 is engaged with the stopper 20 in a unidirectional manner through the non-uniform cross-section of the stopper 20 and the sidewall 11c.

### Method of Preserving Wine Using the Kit of the Present Invention.

In order to preserve the contents of the opened wine bottle the stopper 20 is placed onto the bottle 30 opening. The device 10 is aligned with the stopper 20 and then with downward hand pressure is pushed down so the two injectors pass out of the device 10 through the top part 21 of stopper 20 into the wine bottle 30. Further downward hand pressure will push the tap to release the gas into the first of the injector 18 into the wine bottle 30. As the gas passes into the wine bottle 30, the gas will push out air already into the bottle 30 through the exhaust pipe 19 and vent it to the atmosphere. The more empty the bottle 30 is of wine, the longer the gas injection needs to be, but 5 seconds should generally be sufficient for a half full bottle and 10 seconds for a nearly empty bottle.

Next the user would release some of the downward hand pressure allowing the device 10 to rise to closing the valve 18. Any excess pressure in the bottle would be dissipated by allowing the gases in the bottle to vent to the atmosphere thus equalising the pressure in the bottle to the atmosphere. On completion the user would raise the device 10 further and remove the device 10 altogether leaving the stopper 20 in place with the inert gas sealed over the wine.

Generally, the present invention relates to a kit to seal and preserve a partly drunk bottle of wine by injecting and leaving an unpressurised blanket of inert gas into the bottle through a self-sealing stopper 20. The device 10 contains a replaceable canister of compressed gas and is designed so that the whole injecting of gas process is carried out with a simple push down of the device onto the bottle. At the end of the process the wine will be kept in perfect condition for many months by leaving the stopper 20 in the bottle.

What is claimed is:

1. A device for preserving wine in a bottle, comprising:
a housing having a movable wall movable between a wall first position and a wall second position, and the moveable wall comprising an injector aperture therethrough, the housing further comprising an elongate injector extending from a gas supply to a distal end of the injector, wherein the distal end of the injector extends through the injector aperture by less than a preset amount in the wall first position and by more than the preset amount in the wall second position.

2. The device according to claim 1, wherein the movable wall is biased into the first wall position.

3. The device according to claim 1, wherein the movable wall is movable within a generally cylindrical sidewall of the housing.

4. The device according to claim 3, wherein the generally cylindrical sidewall has a non-circular cross-section.

5. The device according to claim 1, wherein the gas supply is a pressurised gas cylinder.

6. The device according to claim 5, wherein the gas is a non-oxygenating gas selected from the group consisting of argon, carbon dioxide, helium, nitrogen and mixtures thereof.

7. The device according to claim 1, wherein the injector is fluidly connected to the gas supply via a valve which allows fluid connection between the gas supply to the injector in the wall second position and prevents said fluid connection gas from the gas supply in the wall first position.

8. The device according to claim 7, wherein the valve switches between allowing fluid flow and preventing fluid flow when the movable wall is in an intermediate position between the first and second position.

9. The device according to claim 1, further comprising an elongate exhaust pipe extending from the housing interior to a distal end.

10. The device according to claim 9, wherein the exhaust pipe is generally parallel with the injector.

11. The device according to claim 10, wherein the exhaust pipe distal end extends through the movable wall in the wall second position less than the injector distal end.

12. The device according to claim 9, wherein the exhaust pipe surrounds the injector.

13. The device according to claim 1, wherein the housing is sized for one-handed operation.

14. The device according to claim 1, wherein the housing includes a port for preventing gas pressure therein.

15. The device according to claim 1, wherein the housing has a removable end cap for access to the gas supply.

16. A kit comprising a device comprising a housing having a movable wall movable between a wall first position and a wall second position and the moveable wall comprising an injector aperture therethrough, the housing further comprising an elongate injector extending from a gas supply to a distal end of the injector, wherein the distal end of the injector extends through the injector aperture by less than a preset amount in the wall first position and by more than the preset amount in the wall second position and a stopper comprising a top face and a bottom face and a generally gas impervious body extending from said top face to said bottom face.

17. The kit according to claim 16, wherein the top face of the stopper comprises an injector opening for the injector.

18. The kit according to claim 16, wherein the top face of the stopper comprises an opening for the exhaust pipe.

19. The kit according to claim 16, wherein the stopper comprises one or more fluid channels between the top face and bottom face wherein the one or more fluid channels allow fluid connection therebetween only when the movable wall of the device is in the wall second position.

20. The kit according to claim 16, wherein the stopper comprises a self-sealing material.

21. The kit according to claim 16, wherein the stopper comprises a non-circular cross-section.

22. The kit according to claim 21, wherein the cross-section of the stopper is matched to the sidewall of the device such that the interior surface of the sidewall can slide over the exterior edge of the stopper.

23. A method of re-corking a wine bottle having liquid up to a level therein, the method comprising the steps of:
a) introducing a device comprising a housing having a movable wall movable between a wall first position and a wall second position the moveable wall comprising an injector aperture therethrough, the housing further comprising an elongate injector extending from a gas supply to a distal end of the injector, wherein the distal end of the injector extends through the injector aperture by less than a preset amount in the wall first position and by more than the preset amount in the wall second position, and a stopper comprising a top face and a bottom face, and a gas impervious body extending between the top face and the bottom face, and an injector opening in the top face of the stopper, into an open wine bottle;
b) aligning the injector aperture with the injector opening;
c) moving the movable wall in the wall first position against the top face of the stopper;
d) moving the movable wall to the wall second position against the top face of the stopper;
e) maintaining the device with the movable wall in the wall second position for a period of time sufficient to substantially displace the air above the liquid level with a gas from the gas supply; and
separating the device from the stopper whereby the stopper remains in the wine bottle.

24. (canceled)

25. (canceled)

26. (canceled)
